(19) United States
(12) Patent Application Publication
(10) Pub. No.: US 2025/0335979 A1
(43) Pub. Date: Oct. 30, 2025

(54) Characterization Model

(71) Applicant: Comcast Cable Communications, LLC, Philadelphia, PA (US)

(72) Inventors: Yuan Gao, London (GB); Shuai Yuan, London (GB); Francis McLaughlin, Brooklyn, NY (US)

(21) Appl. No.: 18/647,355

(22) Filed: Apr. 26, 2024

(51) Int. Cl. G06Q 30/08; G06Q 30/0203

(52) U.S. Cl. CPC G06Q 30/08; G06Q 30/0203

(57) ABSTRACT

Systems, apparatuses, and methods are described for a positive/negative/unknown (PNU) model. The PNU model may be used to make predictions based on partially observed systems. For example, the PNU model may directly train on auction data, and/or unlabeled data to classify the probability of each of the PNU labels and calculate an ideal bid amount based on the classification.

### BACKGROUND

A first-price auction is a type of auction where the first-place bid amount is the winning bid. In first-price auctions, the winning bid amount is also the same as the price paid. A second-price auction is another type of auction, in which the first-place bid amount is also the winning bid amount. However, in second-price auctions, the price paid is not the same as the winning bid amount; rather, the price paid is the same as the second-place bid amount. These and other types of auctions can be analyzed and combined to create a hybrid data model and bidding process, as discussed in the disclosure.

### SUMMARY

The following summary presents a simplified summary of certain features. The summary is not an extensive overview and is not intended to identify key or critical elements.

Systems, apparatuses, and methods are described for a positive/negative/unknown (PNU) model. The PNU model may be used to make predictions based on partially observed systems. A global bid shading model (e.g., a second-price model) may be trained on historical data such as bucketized second-price auction clearing prices. Bucketization generally refers to generating price buckets based on quantiles of bid prices. Price buckets may be generated based on the clearing price for the second-price model. For the first-price model, price buckets may be generated based on the bid price. The PNU model, for example, may directly train on auction data (e.g., first-price auction data) and/or other unlabeled data to classify the probability of each of the PNU labels and calculate an ideal bid amount based on the classification.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIG. 3A is a table showing an example of PNU categorization.

FIG. 3B is a table showing an example of features of data.

FIG. 4 is an architectural diagram showing an example neural network.

FIGS. 5A-5B are flow charts showing an example method for PNU categorization.

FIG. 6 is a flow chart showing an example method for bidding using PNU data.

FIG. 7 is a sequence diagram showing an example of PNU categorization.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

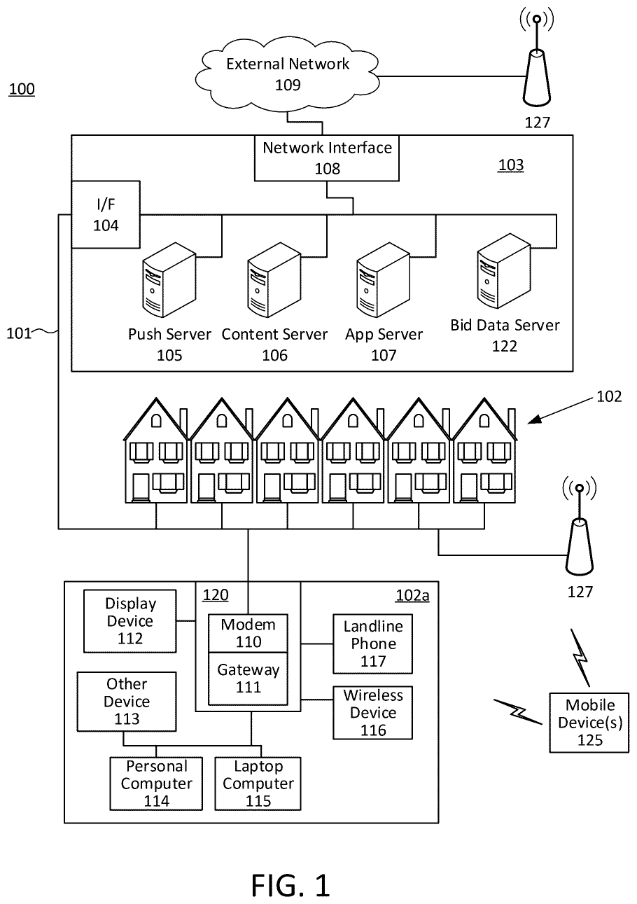

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107 and 122, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The bid data server 122 may comprise bid request data, clearing price data, market price data, win/loss data, other auction data, and/or any other data used by the PNU model. The local office 103 may comprise additional servers, such as the bid data server 122 (described below), additional push, content, and/or application servers, and/or other types of servers. Although shown separately, the push server 105, the content server 106, the application server 107, the bid data server 122, and/or other server(s) may be combined. The servers 105, 106, 107, and 122, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone-DECT phones), mobile phones, mobile televisions, personal digital assistants (PDA)), landline phones 117 (e.g., Voice over Internet Protocol-VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on-or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

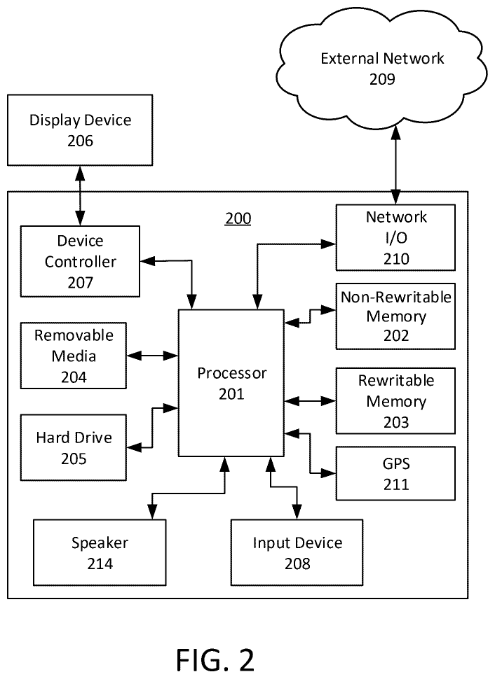

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein. The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

A PNU model may be used to make predictions based on partially observed systems, such as first-price auctions and/or second-price auctions. A global bid shading model (e.g., a second-price model) may be trained on bucketized first-price auction clearing prices. In contrast to first-price models, second-price models may not account for the second-price data. Further, first-price data may not have the same distributions as the second-price data. In some instances, first-price auction data may include clearing prices but may not reflect the true market prices, which may deprive the model of ground-truth labels for training. This happens because first-price auctions may be blind auctions where bidders may only know their own bid amounts, and may not the bid amounts of any other bidders. In those cases, bid price data may be tracked with internal data sources (e.g., the bid data server 122 and/or other data sources). Auction result data (e.g., win/loss data) may be retrieved from auction exchanges and/or stored in a server, such as bid data server 122. The PNU model, for example, may directly train on auction data (e.g., first-price auction data), and/or unlabeled data to classify the probability of each of the PNU labels and calculate an ideal bid amount based on the classification. By training on first-price data and using heuristic roles to label first-price data with PNU labels, labeled first-price data can be used for second-price models.

Further, second-price auctions and first-price auctions may be different because the second-price auction may be incentive compatible. Bidders may tend to bid a more accurate price in order to maximize their gains. In this case, the clearing price may be stable. In contrast, in a first-price auction, when bidders win a bid request, bidders may tend to lower their bid price in later auctions to determine the lowest winning price, and so the clearing price of similar requests may be affected by the bidder's different behavior. This means that, in a second-price auction, the clearing price may more accurately reflect what the bidders paid.

Additionally, second-price models may build upon an assertion that clearing price distributions in the second-price are or could be similar or the same as the first-price auction. Taking this into account, the model may be trained with second-price auction data that may be utilized to make predictions in the first-price auction environment. However, in some instances, the potential differences of the distribution may be ignored. Bucketization of bid prices may comprise generating price buckets based on quantiles of the bid prices that may be empirically based. For example, if the range of bid prices within a dataset is [0, 3000], then, for example, 33% and 66% of the quantile may be used to split the price buckets such that the price buckets would be [0, 1000], [1001, 2000], and [2001, 3000].

A bucket may be labeled as “positive” with respect to a bid request, for example, if it is known that the bid request belongs to this price bucket and it is known that the bid request is or would be the winning bid amount. A bucket may be labeled as “negative” with respect to a bid request, for example, if it is known that the market price may be equal to or lower than the bid request. A bucket may be labeled as “unknown” with respect to a bid request, for example, if it is unknown whether a bid lower than the bid request can still win (e.g., there is incomplete information relating to whether a bid amount lower than the bid request can win) and/or if it is unknown that whether the bid request is the same as the clearing price (e.g., there is incomplete information relating to whether the bid amount is the same as the clearing price).

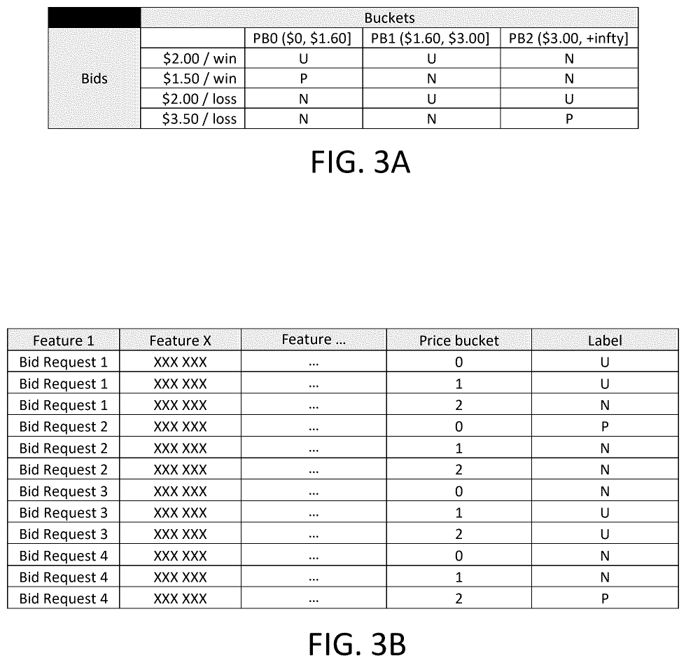

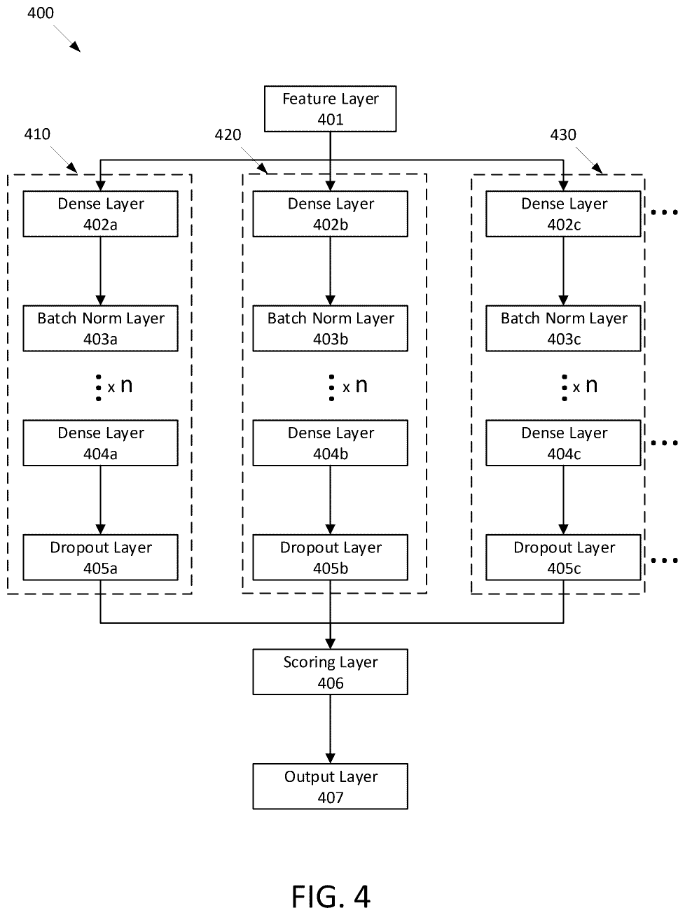

FIG. 3A is a table showing an example of PNU categorization. The example shown in FIG. 3A, depicts an auction for an entity where the bid prices range from $0 to greater than $3.00. In this example, the price buckets (PBs) were generated based on the quantiles of the bid prices as follows: PB0=($0, $1.60], PB1=($1.60, $3.00], and/or PB2=($3.00, infinity). But other auctions might have different results. For example, a $2.00 bid may have won an auction, a $1.50 bid may have won another auction, a $2.00 bid may have lost another auction, and/or a $3.50 bid may have won another auction, in which the auctions may also have the same or similar price buckets PB0, PB1, and PB2.

In the example of FIG. 3A, a $2.00 bid won the auction (e.g., such as shown in the first row of the table in FIG. 3A). As shown, the price bucket PB0 received the label “Unknown” because the bid price of $2.00 exceeds the range of the price bucket of ($0, $1.60] and/or because it may be unknown whether a bid lower than $2.00 can still win the auction. In contrast, the price bucket PB1 received the label “Unknown” because it is unknown if $2.00 is the clearing price of the auction. As used herein, the clearing price may be the price for the entity that is mutually agreed upon by buyers and sellers in the auction. Additionally, as depicted in FIG. 3A, the price bucket PB2 received the label “Negative” because the bid price of $2.00 won the auction, so the market price should be less than or equal to $2.00, and thus outside of the range of the price bucket of ($3.00, infinity).

In FIG. 3A, a $1.50 bid for an entity may win an auction. The price bucket PB0 received the label “Positive” because the bid price of $1.50 won the auction, belongs to this bucket, and/or cannot belong to a lower bucket. The price bucket PB1 received the label “Negative” because the clearing price belongs to PB0 (since the winning bid is below the range of PB1). The price bucket PB2 received the label “Negative” because the clearing price belongs to PB0 (since the winning bid is below the range of PB2).

FIG. 3A also shows how a $2.00 bid for an entity lost an auction (in the third row of the table in FIG. 3A). The price bucket PB0 received the label “Negative” because the bid price of $2.00 exceeds the range of the price bucket and/or lost the auction. The price bucket PB1 received the label “Unknown” because the bid price of $2.00 lost the auction and/or it may be unknown whether the clearing price is in PB1. The price bucket PB2 received the label “Unknown” because the bid price of $2.00 lost the auction and/or it may be unknown whether the clearing price is in PB2.

In FIG. 3A, a $3.50 bid for an entity lost an auction (in the fourth row of the table in FIG. 3A). The price bucket PB0 received the label “Negative” because the bid price is of $3.50 is outside the range of the price bucket. The price bucket PB1 received the label “Negative” because the bid price of $3.50 is outside the range of the price bucket. The price bucket PB2 received the label “Positive” because the winning bid is in this bucket. The clearing price of this auction may be unknown in some instances.

FIG. 3B is a table showing an example of features of data, such as training data used by the PNU model. The data may be, for example, first-price auction data, second-price auction data, and/or other types of data, which may be categorized by the PNU model. The data may be generated from current or historical auction data. Data such as the data shown in the table in FIG.

3B may be used to train the PNU model to output a predicted ideal (e.g., new) bid price based on a scoring function. For example, the trained model may be able to predict probabilities of positive/negative/unknown for each bucket. In FIG. 3B, the rows for Bid Request 1 correspond to the $2.00/win bid request described with respect to FIG. 3A, the rows for Bid Request 2 correspond to the $1.50/win bid request described with respect to FIG. 3A, the rows for Bid Request 3correspond to the $2.00/loss bid request described with respect to FIG. 3A, and/or the rows for Bid Request 4 correspond to the $3.50/loss bid request described with respect to FIG. 3A.

The bid request data may comprise additional features (denoted by Feature X, Feature . . . , etc. in FIG. 3B) such as bidder information, bid time, auction information, and/or other information related to the bid request. Additionally, the features may include features such as DISPLAY_MANAGER, DOMAIN, GEO_CITY, GEO_COUNTRY, INVENTORY_SOURCE, PLATFORM_BROWER, etc. In some instances, additional features may indicate the type of entity, such as an advertisement slot during a feature presentation of a sporting event or an advertisement slot during a rerun of an old sporting event. Additional features may indicate whether the economy is in a recession. Although there are only two columns of features described in FIG. 3B (i.e., Feature X, Feature . . . ), there may be more or less columns with varying combinations of features without departing from the scope of the disclosure. These and/or other additional features may be considered in the feature layer of a neural network, as will be described herein.

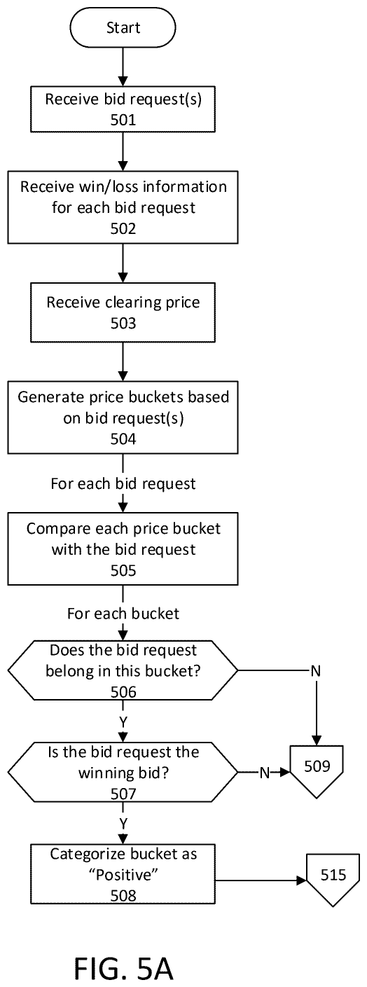

FIG. 4 is an architectural diagram showing an example neural network. A neural network is a type of machine learning algorithm which attempts to work similarly to how the human brain is organized and processed information using a network of interconnected neurons. A deep learning model uses neural networks to process data. A deep learning classification model may fit data such as the dataset of FIG. 3B. FIG. 4 depicts an example of how the PNU model may be implemented using a deep learning model with a neural network.

As shown in FIG. 4, the neural network 400 comprises a plurality of branches. While not strictly required, according to aspects of the disclosure, the number of branches corresponds to the number of price buckets. A branch (e.g., branches 410, 420, 430) of the neural network may train on data from its corresponding bucket. And each branch (e.g., branches 410, 420, 430) output probabilities for each of PNU for their corresponding buckets. The neural network may comprise a feature layer 401, which may encode categories into numerical vector representations. The encoding may leverage feature hashing as the encoding method in the feature layer for categorical features. For example, with a feature set of: ['orange', ‘yellow’, ‘black’], a predefined hashing space of 10 (which may be chosen to avoid hash collisions), and hashing values for the features of {[‘orange’: 1], [‘yellow’, 2], [‘black’,3]}, then the numerical representation of the features may be {[‘orange’: 0100000000], ['yellow', 0010000000], [‘black’, 0001000000]}. In some instances, the feature layer 401 may encode features such as the state of the economy, the type of entity, and/or other contextual features related to the bid request into numerical vector representations which may be processed by the neural network.

As shown in FIG. 4, the neural network includes dense layers 402a-402c . . . The dense layer 402a-402c may be a fully connected layer of the neural network, in which neurons may receive input from the feature layer 401. The dense layer 402a-402c may output vectors. The neural network may comprise a batch normalization (norm) layer 403a-403c . . . The batch norm layer 403a-403c may normalize the data from the previous layers. Batch normalization is used in deep learning and ensures that the mean output is close to zero and the output standard deviation is close to one. The neural network may comprise further batch normalization layers 403a-403c . . . x n. Batch normalized is applied to avoid internal covariate shift and to increase the speed of the neural network. The neural network includes a dense layer 404a-404c . . . The dense layer 404a-404c may comprise normalized data from the previous batch norm layer(s). The neural network includes a dropout layer 405a-405c . . . The dropout layer 405a-405c may be a semi-connected layer. A randomly selected quantity (e.g., percentage) of the neurons from the previous dense layer 404a-404c 404c may be selected to be unlinked. Unlinking some of the neurons may provide advantages such as increasing efficiency by simplifying computation.

FIG. 4 also depicts a scoring layer 406. The scoring layer 406 determines which branch (e.g., branches 410, 420, 430) has the highest score using an optimization function such as the following function:

$$S = P \cdot C = {\sum }_{i ∈ \{ p , n , u \}} {P}_{i} * {C}_{i} ,$$

where Pᵢ represents the probability of PNU per bucket and Cᵢ represents the coefficients, respectively. The highest score may be the score calculated from the previous functions, and the coefficients may be empirical-based parameters that may be adjusted accordingly. The equation may increase in complexity with the addition of other variables and/or by dynamically varying current and/or other variables in the function.

The neural network includes an output layer 407. The output layer 407 may output the ideal bid price. The output layer 407 may be initialized with the bucket upper bounds and may take the output of the PNU score layer as the input and output the ideal bid price.

The PNU model may be generalized, for example, to make predictions based on partially observed outcomes. For a partially observable system (e.g., a first-price auction), the goal may be to maximize success. In this case, maximizing success may entail predicting an ideal bid which may be the lowest possible winning bid.

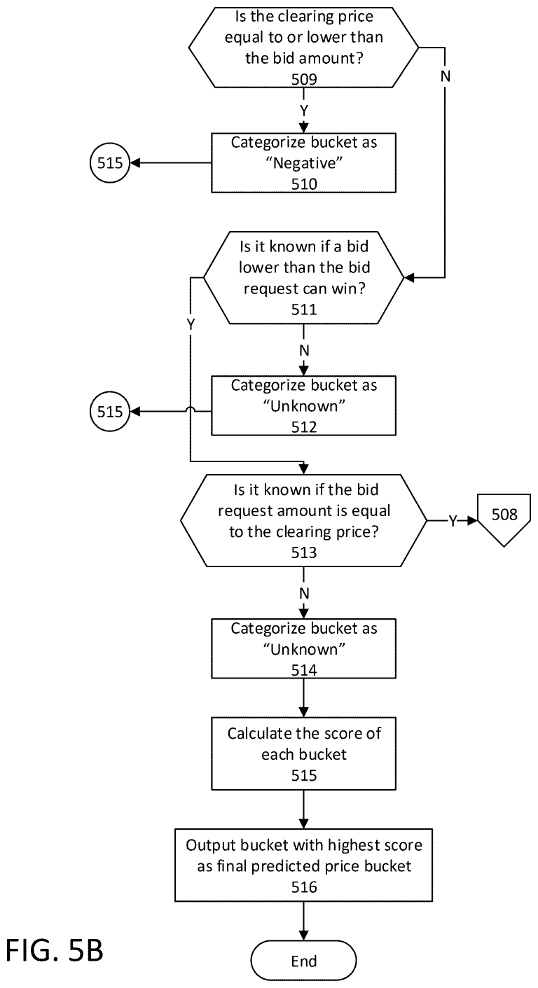

FIGS. 5A-5B are flow charts showing an example method for PNU categorization. At 501, one or more bid requests for an auction may be received. For example, the bid data server 122 may receive the one or more bid requests. Additionally or alternatively, the one or more bid requests may be received, for example, from the bid data server 122. At 502, win/loss information for a bid request (e.g., each bid request) may be received. For example, the bid data server 122 may receive the win/loss information. Additionally or alternatively, the win/loss information may be received, for example, from the bid data server 122. At 503, one or more clearing prices for the auction may be received. For example, the bid data server 122 may receive the one or more clearing prices. Additionally or alternatively, the one or more clearing prices may be received, for example, from the bid data server 122.

At 504, price buckets may be generated based on the bid request(s). For example, price buckets such as the price buckets described with respect to FIGS. 3A-3B may be generated. For a bid request (e.g., for each bid request), at 505, each bucket may be compared to the bid request(s). For a price bucket (e.g., for each price bucket), at 506, a determination may be made as to whether the bid request belongs to the price bucket. In the case of the “yes” determination, at 507, a determination may be made as to whether the bid request is the winning bid in the auction. In the case of a “yes” determination, at 508, the bucket may be categorized as “Positive”.

In the case of a “no” determination at 506 and/or at 507, a determination may be made as to whether the clearing price is equal to or lower than the bid amount. In the case of a “yes” determination, at 510, the bucket may be categorized as “Negative”. In the case of a “no” determination, at 511, a determination may be made as to whether there is information indicating that a bid lower than the bid request can win the auction. In the case of a “no” determination, at 512, the bucket may be categorized as “Unknown”. In the case of a “yes” determination, at 513, a determination may be made as to whether there is information indicating that the bid request is equal to the clearing price. In the case of a “no” determination, at 514, the bucket may be categorized as “Unknown”. In the case of a “yes” determination, at 508, the bucket may be categorized as “Positive”.

At 515, the score of a bucket (e.g., each bucket) may be calculated. For example, the score may be calculated using a scoring function such as the optimization function described herein. At 516, the bucket with the highest score may be selected as the final predicted price bucket. An indication of the final predicted price bucket may be output.

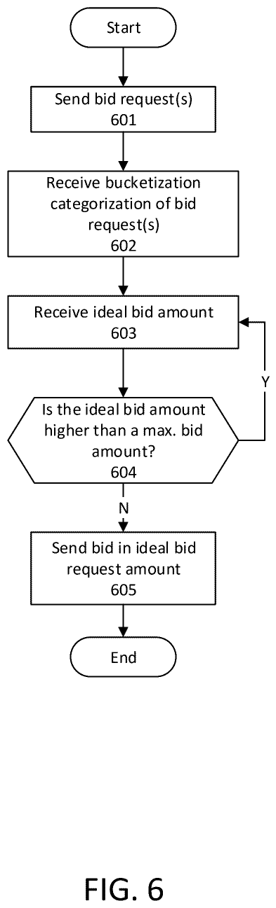

FIG. 6 is a flow chart showing an example method for bidding using PNU data. At 601, one or more bid requests may be sent. For example, the one or more bid requests may be sent to the PNU model. At 602, a bucketization categorization of the one or more bid requests may be received. For example, the bucketization categorization may be such as described with respect to FIGS. 5A-5B. At 603, an ideal bid amount may be received. An ideal bid amount may be determined, for example, based on the bucketization categorization. For example, based on trained data (e.g., such as described with respect to FIG. 3B), the PNU model may output an ideal bid price that may be the lowest possible winning bid price. At 604, a determination may be made as to whether the ideal bid amount is higher than a maximum bid amount. For example, the maximum bid amount may be determined to be a maximum amount that a bidder is willing to pay. In the case of the “yes” determination, at 603, another ideal bid amount, for example, the maximum bid amount, may be received. In the case of a “no” determination, a bid in the ideal bid amount may be sent.

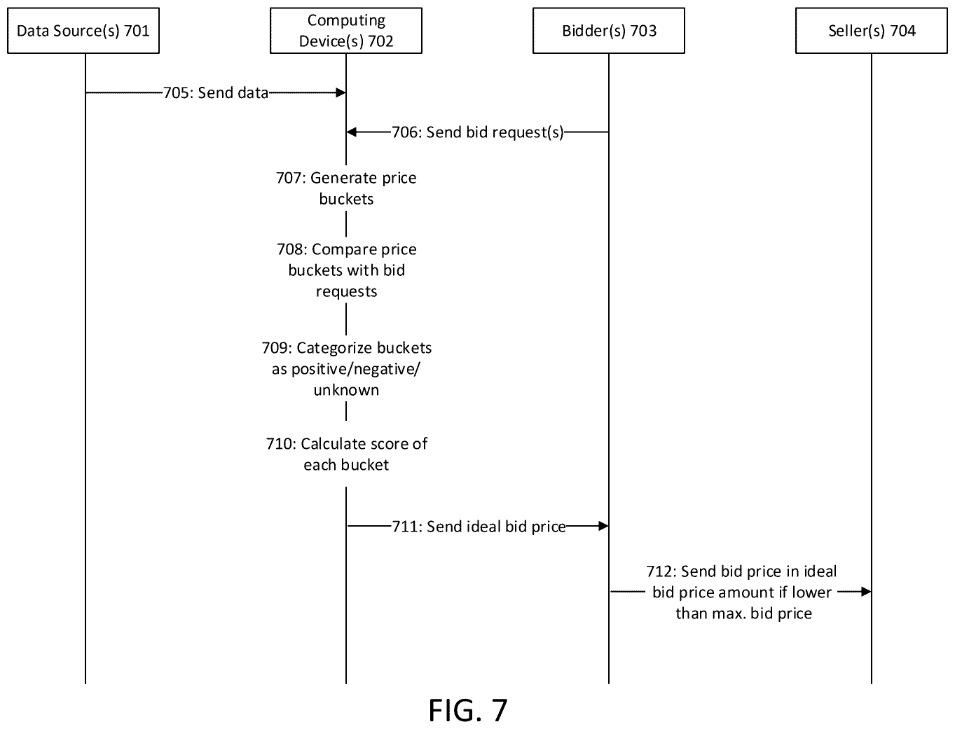

FIG. 7 is a sequence diagram showing an example of PNU categorization. The sequence diagram of FIG. 7 may comprise data source(s) 701, computing device(s) 702, bidder(s) 703, seller(s) 704, and/or other actors. At 705, data (e.g., for one or more entities in an auction) may be sent (e.g., transmitted) from the data source(s) 701 to the computing device(s) 702. In some instances, the data may be sale price data and/or other types of data indicating value. For example, the bid data server 122 may send and/or receive the data from the data source(s) 701 and/or from the computing device(s) 702, respectively. At 706, one or more bid request(s) may be sent (e.g., transmitted) from the bidder(s) 703 to the computing device(s) 702. At 707, price buckets may be generated by the computing device(s) 702. For example, price buckets such as the price buckets described with respect to FIG. 3B may be generated. At 708, the price buckets may be compared with a bid request (e.g., each bid request) by the computing device(s) 702. For example, the price buckets may be compared with a bid request such as described with respect to FIGS. 5A-5B. At 709, the price buckets may be categorized as positive/negative/unknown with respect to a bid request (e.g., each bid request) by the computing device(s) 702. For example, the buckets may be categorized such as described with respect to FIGS. 3A, 5A, and/or 5B. At 710, a score may be calculated for each bucket by the computing device(s) 702, for example, such as described with respect to FIG. 4. At 711, an ideal bid price may be sent (e.g., transmitted) from the computing device(s) 702 to the bidder(s) 703. For example, the ideal bid price may be determined and/or sent such as described with respect to FIG. 6. At 712, a bid price in the ideal bid price amount may be sent (e.g., transmitted) from the bidder(s) 703 to the seller(s) 704, for example, if the ideal bid amount is the maximum bid price (e.g., such as described with respect to FIG. 6).

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
receiving, by a computing device, data associated with one or more assets in an auction;
receiving information indicating price buckets for the auction;
receiving, for one of the one or more assets:
a bid request; and
an indication of whether the bid request resulted in a win or a loss;
determining, via a machine learning model and based on the bid request and based on the indication of whether the bid request resulted in a win or a loss, whether the price bucket is categorized as one of positive, negative, and unknown; and
calculating, based on the determining, a bid price.

2. The method of claim 1, wherein the receiving further comprises receiving data from first-price auctions.

3. The method of claim 1, wherein the receiving further comprises receiving data from second-price auctions.

4. The method of claim 1, wherein the price buckets are generated based on a quantile of a plurality of bid requests.

5. The method of claim 1, wherein determining that a price bucket is categorized as positive comprises determining that a bid request belongs to the price bucket and that it is a winning bid request.

6. The method of claim 1, wherein determining that a price bucket is categorized as negative comprises determining that a market price for one or more assets is equal to or lower than the bid request.

7. The method of claim 1, wherein determining that a price bucket is categorized as unknown is based on one or more of:
(a) determining that there is incomplete information relating to whether a bid amount is lower than the bid request and can win; and
(b) determining that there is incomplete information relating to whether a bid amount is the same as a clearing price for the auction.

8. The method of claim 1, wherein the machine leaning model comprises a classification model having one branch of a neural network for each of the price buckets.

9. The method of claim 1, further comprising:
receiving additional data; and
training the machine learning model based on the additional data.

10. A method comprising:
receiving, by a computing device, data related to one or more assets in an auction;
receiving, for one of the one or more assets:
a bid request; and
an indication of whether the bid request resulted in a win or a loss;
determining, based on the bid request the indication of whether the bid request resulted in a win or a loss, whether a price bucket is categorized as one of positive, negative, and unknown; and
calculating, based on the determining, a new bid price.

11. The method of claim 10, wherein the price buckets are generated based on a quantile of bid requests.

12. The method of claim 10, wherein determining that a price bucket is categorized as positive comprises determining that a bid request belongs to the price bucket and that it is a winning bid request.

13. The method of claim 10, wherein determining that a price bucket is categorized as negative comprises determining that a market price for one or more assets is equal to or lower than the bid request.

14. The method of claim 10, wherein determining that a price bucket is categorized as unknown is based on one or more of:
(a) determining that there is incomplete information relating to whether a bid amount is lower than the bid request and can win; and
(b) determining that there is incomplete information relating to whether a bid amount is the same as a clearing price for the auction.

15. The method of claim 10, wherein the determining is further based on a machine leaning model comprising a classification model having one branch of a neural network for each of the price buckets.

16. The method of claim 10, further comprising:
receiving additional data; and
training the machine learning model based on the additional data.

17. A method comprising:
sending, to a computing device, a bid request in an auction;
receiving a bucketization categorization of the bid request;
receiving, based on the categorization, an indication of a new bid amount; and
sending a new bid request in the new bid amount.

18. The method of claim 17, further comprising determining, based on the new bid amount being lower than a maximum bid amount, to send the new bid request.

19. The method of claim 17, further comprising determining, based on the new bid amount being higher than a maximum bid amount, another new bid request, wherein the another new bid request is lower than the maximum bid amount.

20. The method of claim 17, wherein the bucketization categorization is determined via a machine leaning model comprising a classification model having one branch of a neural network for each of a plurality of price buckets.
